(19) United States
(12) Patent Application Publication
(10) Pub. No.: US 2016/0349851 A1
(43) Pub. Date: Dec. 1, 2016

(54) AN APPARATUS AND ASSOCIATED METHODS FOR CONTROLLING CONTENT ON A DISPLAY USER INTERFACE

(71) Applicant: NOKIA TECHNOLOGIES OY, Espoo (FI)

(72) Inventors: Peter Eskolin, Pirkkala (FI); Lauri Jaaskela, Tampere (FI)

(21) Appl. No.: 15/116,640

(22) PCT Filed: Feb. 5, 2015
(86) PCT No.: PCT/IB2015/050882

§ 371 Date: Aug. 4, 2016

(30) Foreign Application Priority Data
Feb. 13, 2014 (GB) 1402524.1

(51) Int. Cl. G06F 3/01; G06F 3/044; G06F 3/0482; G06F 3/0483; G06F 3/0488; G06F 3/0485

(52) U.S. Cl. CPC G06F 3/017; G06F 3/04886; G06F 3/04883; G06F 3/0485; G06F 3/0482; G06F 3/0483; G06F 3/044; G06F 2203/04108; G06F 2203/04803; G06F 2203/04112

(57) ABSTRACT

An apparatus comprising: at least one processor; and at least one memory including computer program code, the at least one memory and the computer program code configured to, with the at least one processor, cause the apparatus to perform at least the following: based on a detected inclination of a hand gesture relative to a display screen displaying content, split the display screen into a first portion displaying the content and a second portion.

### TECHNICAL FIELD

The present disclosure relates to the field of (input and/or output) user interfaces, associated methods, computer programs and apparatus. Certain disclosed aspects/examples relate to portable electronic devices, in particular, so-called hand-portable electronic devices which may be hand-held in use (although they may be placed in a cradle in use). Such hand-portable electronic devices include so-called Personal Digital Assistants (PDAs), mobile telephones, smartphones and other smart devices, smartwatches and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/e-mailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture functions (e.g. using a (e.g. in-built) digital camera), and gaming functions.

### BACKGROUND

An electronic device may have a user interface which allows a user to interact with the device. For example, a device may comprise a touch-sensitive display which a user can touch to provide inputs to the device.

The listing or discussion of a prior-published document or any background in this specification should not necessarily be taken as an acknowledgement that the document or background is part of the state of the art or is common general knowledge. One or more aspects/examples of the present disclosure may or may not address one or more of the background issues.

### SUMMARY

In a first aspect there is provided an apparatus comprising at least one processor and at least one memory including computer program code, the at least one memory and the computer program code configured to, with the at least one processor, cause the apparatus to perform at least the following, based on a detected inclination of a hand gesture relative to a display screen displaying content, split the display screen into a first portion displaying the content and a second portion.

The inclination may be with respect to a particular side of the display screen, wherein the particular side may be one of a left-hand side, right-hand side, top side, bottom side, top-left-hand corner, top-right-hand corner, bottom-left-hand-corner, and bottom-right-hand corner.

In this context, although the particular side may be with respect to the display screen, it will be appreciated that this could also be considered with respect to a side of a user interface used to detect the inclination. In advantageous embodiments, the particular side of the user interface would have a direct correspondence with the display screen, for example the left-hand-side of the user interface would correspond to the left hand side of the display screen.

The apparatus may be configured such that an inclination towards a particular side of the display screen splits the display screen with the first portion being displayed on that particular side of the display screen.

The apparatus may be configured such that an inclination towards a particular side of the display screen splits the display screen with the first portion being displayed on an opposing side to that particular side of the display screen.

It will be appreciated that the inclination towards one side can be considered to be an inclination away from an opposing side.

The apparatus may be configured such that the second portion is displayed on an opposing side of the display to the first portion.

The apparatus may be configured such that the first portion displays one of all of the content and part of the content.

The apparatus may be configured to enable scrolling through content in the first or second portion, which is not obscured by the detected inclination of the hand gesture, based on a particular degree of inclination of the hand gesture.

The apparatus may be configured such that the delineation of the first portion and the second portion is based on the location of the hand gesture relative to the display screen.

The apparatus may be configured to size the split of the display screen into respective first portions and second portions based on a particular degree of inclination of the hand gesture.

The content of the first portion may be associated with a first application and the apparatus may be further configured to enable display of new content, associated with a second application, in the second portion.

The apparatus may be configured to enable one or more of: presentation to a user of an option to select new content to be displayed in the second portion; presentation to a user of a plurality of icons associated with a plurality of content items, wherein selection of a particular icon enables display of the associated particular content in the second portion; and presentation to a user of a plurality of icons associated with a plurality of content items, wherein selection of a particular icon is based on a particular degree of inclination of the hand gesture and enables display of the associated particular content in the second portion.

The apparatus may be configured to, based on a selected at least part of the content, provided for further content in respect of the selected part in the second portion. The selected part may be used as a search entry for searching for further data to be provided in the second portion.

The second portion may comprise a new viewing pane with second content from a background application.

The apparatus may be configured such that the second portion is available for displaying one of second content different to the content displayed in the first portion and new content associated with the first portion.

The apparatus may be configured to enable display of second content in the second portion such that the second content is one of the content of the first portion displayed in a different manner to the display in the first portion and based on different content than the content in the first portion.

The apparatus may be configured to enable display of second content in the second portion such that the second content is displayed at a different scale than the first content displayed in the first portion.

The content of the first portion may comprise one or more of an application screen, data presented within an application screen, and a desktop and second content displayed in the second portion may comprise one or more of an application screen, data presented within an application screen, and a desktop.

The detected hand gesture may be one or more of a hover hand gesture and a touch hand gesture.

The detection of the inclination of the hand gesture may be based on one or more of the detection of a shadow cast by the hand gesture and a three-dimensional shape recognition of the hand gesture.

The apparatus may be configured to one or more of perform the detection of the inclination of a hand gesture and receive an indication of the detected inclination of a hand gesture from another apparatus.

The apparatus may be a portable electronic device, a laptop computer, a mobile phone, a smartphone, a tablet computer, a smart television, a personal digital assistant, a navigation device, a watch, a digital camera, a non-portable electronic device, a server, a desktop computer, a monitor/display, or a module/circuitry for one or more of the same.

In a further aspect there is provided a method comprising, based on a detected inclination of a hand gesture relative to a display screen displaying content, splitting the display screen into a first portion displaying the content and a second portion.

The inclination may be with respect to a particular side of the display screen and wherein the particular side may be one of a left-hand side, right-hand side, top side, bottom side, top-left-hand corner, top-right-hand corner, bottom-left-hand-corner, and bottom-right-hand corner.

The method may comprise splitting the display screen with the first portion being displayed on a particular side of the display screen based on the inclination being towards the particular side of the display screen.

The method may comprise splitting the display screen with the first portion being displayed on an opposing side to a particular side of the display screen based on the inclination being towards the particular side of the display screen.

The second portion may be displayed on an opposing side of the display to the first portion.

The first portion may display one of all of the content and part of the content.

The method may enable scrolling through content in the first or second portion, which is not obscured by the detected inclination of the hand gesture, based on a particular degree of inclination of the hand gesture.

The delineation of the first portion and the second portion may be based on the location of the hand gesture relative to the display screen.

The size of the split of the display screen into respective first portions and second portions may be based on a particular degree of inclination of the hand gesture.

The content of the first portion may be associated with a first application and the apparatus may be further configured to enable display of new content, associated with a second application, in the second portion.

The method may enable one or more of: presentation to a user of an option to select new content to be displayed in the second portion; presentation to a user of a plurality of icons associated with a plurality of content items, wherein selection of a particular icon enables display of the associated particular content in the second portion; and presentation to a user of a plurality of icons associated with a plurality of content items, wherein selection of a particular icon is based on a particular degree of inclination of the hand gesture and enables display of the associated particular content in the second portion.

The method may, based on a selected at least part of the content, provided for further content, in respect of the selected part, in the second portion.

The second portion may comprise a new viewing pane with second content from a background application.

The second portion may be available for displaying one of second content different to the content displayed in the first portion and new content associated with the first portion.

Second content may be displayed in the second portion such that the second content is one of the content of the first portion displayed in a different manner to the display in the first portion and based on different content than the content in the first portion.

The second content may be displayed in the second portion such that the second content is displayed at a different scale than the first content displayed in the first portion.

The content of the first portion may comprise one or more of an application screen, data presented within an application screen, and a desktop and second content displayed in the second portion may comprise one or more of an application screen, data presented within an application screen, and a desktop.

The detected hand gesture may be one or more of a hover hand gesture and a touch hand gesture.

The detection of the inclination of the hand gesture may be based on one or more of the detection of a shadow cast by the hand gesture and a three-dimensional shape recognition of the hand gesture.

The method may perform one or more of the detection of the inclination of a hand gesture and receive an indication of the detected inclination of a hand gesture from another method.

In a further aspect there is provided a computer readable medium comprising computer program code stored thereon, the computer readable medium and computer program code being configured to, when run on at least one processor, perform at least the following, based on a detected inclination of a hand gesture relative to a display screen displaying content, split the display screen into a first portion displaying the content and a second portion.

Corresponding computer programs for implementing one or more of the methods disclosed are also within the present disclosure and encompassed by one or more of the described examples.

In a further aspect there is provided an apparatus, the apparatus comprising means for splitting a display screen displaying content, based on a detected inclination of a hand gesture, into a first portion displaying the content and a second portion.

In a further aspect, there is disclosed an apparatus comprising at least one processor and at least one memory including computer program code, the at least one memory and the computer program code configured to, with the at least one processor, cause the apparatus to perform at least the following, based on one or more of a detected degree of and direction of inclination of a hand gesture relative to a display screen displaying content, split the display screen into a first portion displaying the content and a second portion.

In a further aspect, there is provided an apparatus comprising at least one processor and at least one memory including computer program code, the at least one memory and the computer program code configured to, with the at least one processor, cause the apparatus to perform at least the following, based on the location of a hand gesture relative to a display screen displaying content, split the display screen into a first portion displaying the content and a second portion.

Corresponding methods and computer programs for these aspects are also disclosed, including in appropriate combination with the aforementioned specific embodiments.

The present disclosure includes one or more corresponding aspects, examples or features in isolation or in various combinations whether or not specifically stated (including claimed) in that combination or in isolation. Corresponding means and corresponding functional units (e.g. display screen splitter, inclination detector, content displayer) or performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus embodiment comprising a number of electronic components, including memory and a processor, according to embodiments of the present disclosure;

FIG. 2 illustrates an example apparatus embodiment comprising a number of electronic components, including memory, a processor and a communication unit, according to embodiments of the present disclosure;

FIG. 3 illustrates an example apparatus embodiment comprising a number of electronic components, including memory and a processor, according to embodiments of the present disclosure;

FIGS. 4a-4f illustrate an example comprising detecting a hand gesture, splitting a display screen displaying content into a first portion and a second portion, and displaying the content in the first portion;

FIGS. 5a-5b illustrate an example comprising detecting a hand gesture and splitting a display screen displaying content, in which the location of the split is determined by the location of the detected hand gesture;

FIGS. 6a-6d illustrate examples in which the content displayed in the second portion is a desktop, second content based on the content, and an option to open second content based on a plurality of different content related items; and selection of at least part of the content to provide for further content in the second portion;

FIGS. 7 illustrates schematically an example of a hover-sensitive detector suitable for detecting an inclination of a hand gesture user input according to examples of the present disclosure;

FIGS. 8a-8b illustrate an electronic device in communication with a remote server and a cloud according to embodiments of the present disclosure;

FIG. 9 illustrates a flowchart according to a method of the present disclosure; and

FIG. 10 illustrates schematically a computer readable medium providing a program.

### DESCRIPTION OF EXAMPLE ASPECTS

Certain embodiments disclosed herein may be considered to provide an apparatus comprising at least one processor and at least one memory including computer program code, the at least one memory and the computer program code configured to, with the at least one processor, cause the apparatus to perform at least the following, based on a detected inclination of a hand gesture relative to a display screen displaying content, split the display screen into a first portion displaying the content and a second portion.

For example, a user may position their hand over a portion of a display screen (an input and output user interface) that is displaying content. The display may detect the hand gesture and split the screen into a first portion that is not underneath the user's hand and then display the content in the first portion. In this case, the user interface used to detect the hand is part of the display screen such that the hand gesture over the display is detected. In other examples the user interface used to detect the hand gesture may be separate and not be part of the display screen. In some examples, an appropriate relationship between the hand gesture detector and the display screen is included to ensure performance of embodiments according to the present disclosure.

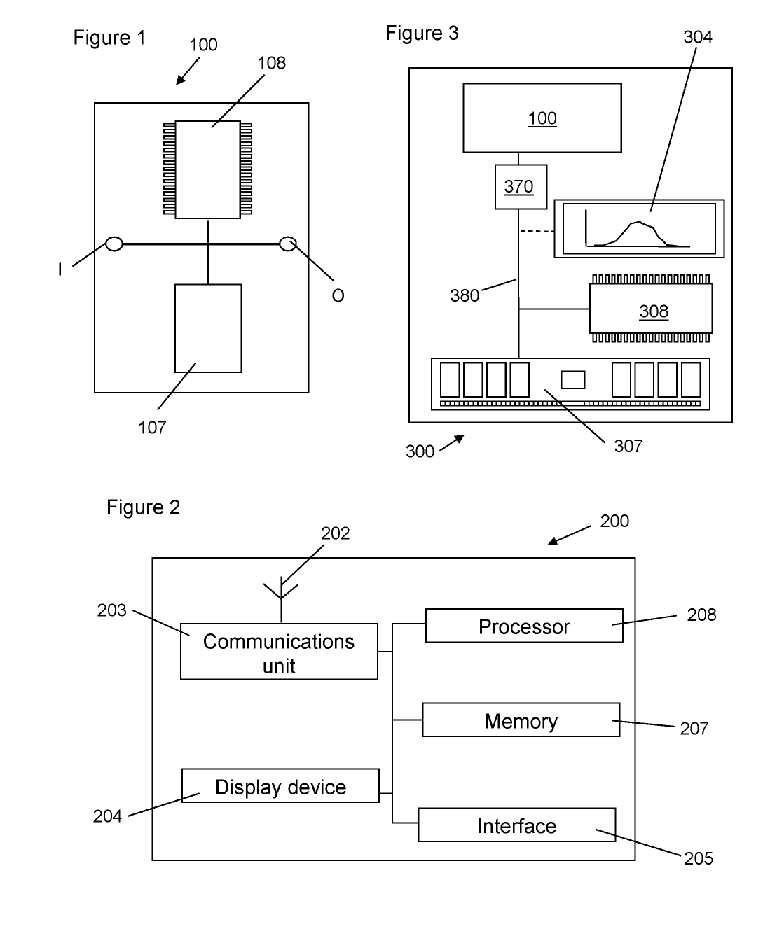

FIG. 1 shows an apparatus 100 comprising memory 107, a processor 108, input I and output O. In this embodiment only one processor and one memory are shown but it will be appreciated that other embodiments may utilise more than one processor and/or more than one memory (e.g. same or different processor/memory types).

In this embodiment the apparatus 100 is an Application Specific Integrated Circuit (ASIC) for a portable electronic device with a touch sensitive display. In other embodiments the apparatus 100 can be a module for such a device, or may be the device itself, wherein the processor 108 is a general purpose Central Processing Unit (CPU) of the device and the memory 107 is general purpose memory comprised by the device.

The input I allows for receipt of signalling to the apparatus 100 from further components, such as components of a portable electronic device (like a touch-sensitive or hover-sensitive display) or the like. The output O allows for onward provision of signalling from within the apparatus 100 to further components such as a display screen, speaker, or vibration module. In this embodiment the input I and output O are part of a connection bus that allows for connection of the apparatus 100 to further components.

The processor 108 is a general purpose processor dedicated to executing/processing information received via the input I in accordance with instructions stored in the form of computer program code on the memory 107. The output signalling generated by such operations from the processor 108 is provided onwards to further components via the output O.

The memory 107 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor 108. The internal connections between the memory 107 and the processor 108 can be understood to, in one or more example embodiments, provide an active coupling between the processor 108 and the memory 107 to allow the processor 108 to access the computer program code stored on the memory 107.

In this example the input I, output O, processor 108 and memory 107 are all electrically connected to one another internally to allow for electrical communication between the respective components I, O, 107, 108. In this example the components are all located proximate to one another so as to be formed together as an ASIC, in other words, so as to be integrated together as a single chip/circuit that can be installed into an electronic device. In other examples one or more or all of the components may be located separately from one another.

FIG. 2 depicts an apparatus 200 of a further example embodiment, such as a mobile phone. In other example embodiments, the apparatus 200 may comprise a module for a mobile phone (or PDA or audio/video player), and may just comprise a suitably configured memory 207 and processor 208.

The example embodiment of FIG. 2 comprises a display device 204 such as, for example, a liquid crystal display (LCD), e-lnk, hover-screen or touch-screen user interface. The apparatus 200 of FIG. 2 is configured such that it may receive, include, and/or otherwise access data. For example, this example embodiment 200 comprises a communications unit 203, such as a receiver, transmitter, and/or transceiver, in communication with an antenna 202 for connecting to a wireless network and/or a port (not shown) for accepting a physical connection to a network, such that data may be received via one or more types of networks. This example embodiment comprises a memory 207 that stores data, possibly after being received via antenna 202 or port or after being generated at the user interface 205. The processor 208 may receive data from the user interface 205, from the memory 207, or from the communication unit 203. It will be appreciated that, in certain example embodiments, the display device 204 may incorporate the user interface 205. Regardless of the origin of the data, these data may be outputted to a user of apparatus 200 via the display device 204, and/or any other output devices provided with apparatus. The processor 208 may also store the data for later use in the memory 207. The memory 207 may store computer program code and/or applications which may be used to instruct/enable the processor 208 to perform functions (e.g. read, write, delete, edit or process data).

FIG. 3 depicts a further example embodiment of an electronic device 300, such as a tablet personal computer, a portable electronic device, a portable telecommunications device, a server or a module for such a device, the device comprising the apparatus 100 of FIG. 1. The apparatus 100 can be provided as a module for device 300, or even as a processor/memory for the device 300 or a processor/memory for a module for such a device 300. The device 300 comprises a processor 308 and a storage medium 307, which are connected (e.g. electrically and/or wirelessly) by a data bus 380. This data bus 380 can provide an active coupling between the processor 308 and the storage medium 307 to allow the processor 308 to access the computer program code. It will be appreciated that the components (e.g. memory, processor) of the device/apparatus may be linked via cloud computing architecture. For example, the storage device may be a remote server accessed via the internet by the processor.

The apparatus 100 in FIG. 3 is connected (e.g. electrically and/or wirelessly) to an input/output interface 370 that receives the output from the apparatus 100 and transmits this to the device 300 via data bus 380. Interface 370 can be connected via the data bus 380 to a display 304 (touch-sensitive or otherwise) that provides information from the apparatus 100 to a user. Display 304 can be part of the device 300 or can be separate. The device 300 also comprises a processor 308 configured for general control of the apparatus 100 as well as the device 300 by providing signalling to, and receiving signalling from, other device components to manage their operation.

The storage medium 307 is configured to store computer code configured to perform, control or enable the operation of the apparatus 100. The storage medium 307 may be configured to store settings for the other device components. The processor 308 may access the storage medium 307 to retrieve the component settings in order to manage the operation of the other device components. The storage medium 307 may be a temporary storage medium such as a volatile random access memory. The storage medium 307 may also be a permanent storage medium such as a hard disk drive, a flash memory, a remote server (such as cloud storage) or a non-volatile random access memory. The storage medium 307 could be composed of different combinations of the same or different memory types.

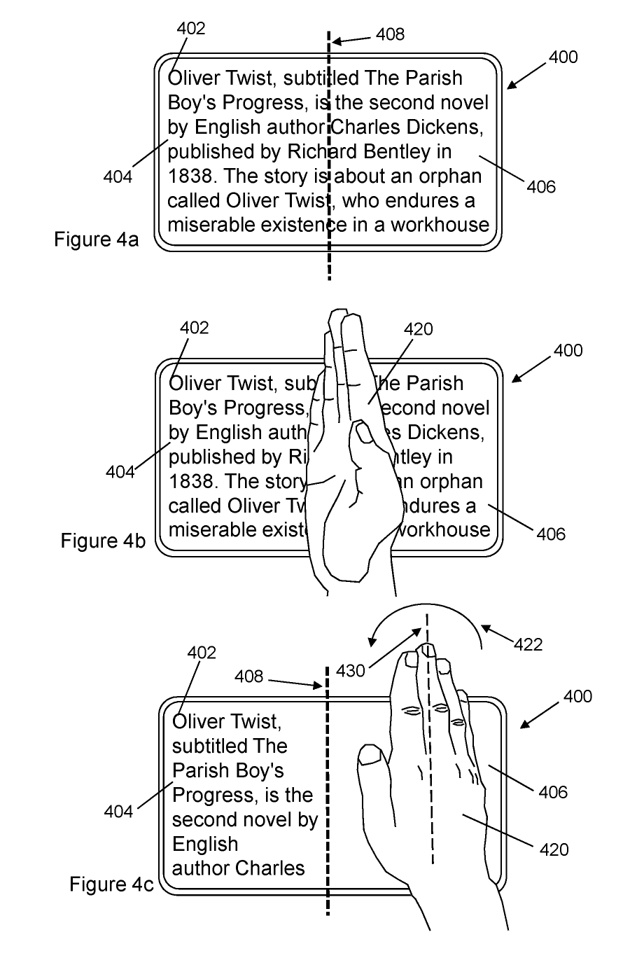

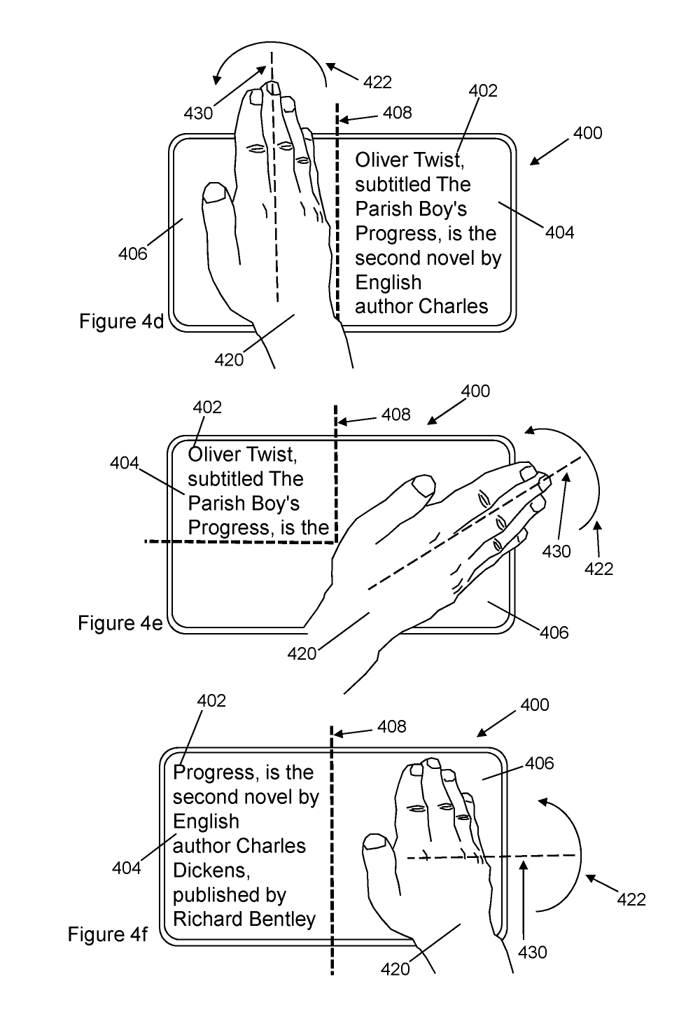

FIGS. 4a-4f show an apparatus comprising at least one processor and at least one memory including computer program code, the at least one memory and the computer program code configured to, with the at least one processor, cause the apparatus to perform at least the following: based on a detected inclination of a hand gesture relative to a display screen 400 displaying content 402, split the display screen 400 into a first portion 404 displaying the content and a second portion 406. Initially, the display screen 400 may display content 402 across the full area of the display screen 400. A user of the apparatus may prefer the content 402 to be displayed on only a first portion 404 of the screen, such that a remaining second portion 406 of the screen may be available to display other content. This requires splitting the screen along a boundary 408 that divides the screen into the respective first portion 404 and second portion 406. To enable this splitting of the screen 400, a user may interact with the apparatus by placing their hand 420 proximal to the display screen 400 and then making a hand gesture that comprises inclining their hand 420 at an angle 422 relative to the display screen 400. The apparatus may be configured to detect the user's hand gesture, and in particular the inclination 422 of the hand gesture relative to the screen 400. The apparatus may then split the screen along a boundary 408, into a first portion 404 and a second portion 406, and display the content 402 on the first portion 404 of the screen 400. In other embodiments (not shown), the hand gesture may be provided on a hand gesture detector which is remote to the display screen 400, rather than part of the display screen 400 itself.

In the example shown in FIG. 4c, the user has inclined their hand 420 at an angle 422 such that their palm is inclined towards the left-hand side of the screen 400 and the apparatus is configured to detect this and display the content 402 in a first portion 404 located on the left-hand side of the screen 400. In this example, the user inclines their hand by rotating it about an axis 430 approximately parallel to the middle finger of the hand 420. It will be appreciated that the user may incline their hand towards any side of the screen 400, including any of the left-hand side, right-hand side, top side, bottom side, top-left-hand corner, top-right-hand corner, bottom-left-hand corner and bottom-right-hand corner. The apparatus may be configured such that an inclination towards a particular side of the display screen 400 splits the display screen with the first portion being displayed on that particular side of the display screen. The apparatus may be configured such that an inclination towards a particular side of the display screen splits the display screen with the first portion being displayed on an opposing side to that particular side of the display screen. For example, the apparatus may be configured such that when the user inclines their hand towards the left-hand-side of the display screen, the display screen is split with first portion being displayed on the right-hand-side of the display screen.

In some examples, the apparatus may be configured such that the second portion is displayed on an opposing side of the display to the first portion, as in FIG. 4c where the first portion 404 is displayed on the left-hand-side of the display screen 400 and the second portion 406 is displayed on the right-hand-side of the display screen 400. Similarly, in some examples, as in FIG. 4d, the user may incline their hand 420 towards the left-hand-side of the screen 400, such that the screen 400 is split into a first portion 404 on the right-hand-side of the screen 400 and a second portion 406 on the left-hand-side of the screen 400. In alternative examples to those shown in FIGS. 4c and 4d, the first portion 404 may appear on the respective left and right hand sides of FIGS. 4c and 4d based on hand gestures towards the right (rather than left as shown in FIGS. 4c and 4d).

In some examples, the apparatus may be configured such that the first portion displays one of all of the content and part of the content. For example, FIG. 4c illustrates the example where the first portion 404 displays only part of the content that was originally displayed on the entire display screen 400. In some examples, all of the content may be displayed in the first portion in which case the content will be reduced in scale relative to the original display on the entire screen.

It will be appreciated that the boundary 408 between the first portion 404 and the second portion 406 of the display screen 400 need not be a straight line as illustrated in FIGS. 4c and 4d. For example, the first portion 404 may be the top-left-hand corner of the display screen 400, as in FIG. 4e. In this case, the boundary 408 may consist of a first straight line and a second straight line that intersect at right angles such that the first portion 404 may consist of a rectangular region located at the top-left-hand corner of the display screen 400. Selection of the top-left-hand corner of the display screen 400 as the first portion 404 may be enabled by a user placing their hand 420 across the bottom-right-hand corner of the display screen 400 and then inclining their hand 420 towards the top-left-hand corner of the display screen 400. In other examples (not shown) selection of the top-left-hand corner may be enabled by a user placing their hand over the top-left-hand corner of the display screen and then inclining their hand towards the top-left-hand corner of the display screen. Of course, the boundary 408 need not be straight-lined, and may comprise one or more curves, for example, it could define a circular/spherical bubble, including a speech bubble (not shown). The splitting of the screen need not be in one of an x or y orthogonal direction as shown in the figures but may, in certain cases, be in both x and y directions i.e. diagonally screen splitting (not shown).

It will be appreciated that whereas FIGS. 4a and 4b illustrate an example where the content is displayed on the entire screen, other examples may include the initial display of content on only an initial portion of the screen that is not encompassing the entire screen. The user may perform a hand gesture that splits only the initial portion of the display screen into a first portion that displays the content and a second portion. For example, the initial portion may comprise the left-hand-side of the screen and the detected hand gesture may split the initial left-hand-side portion of the screen into a first portion located in the top-left-hand corner and a second portion located in the bottom-left-hand corner of the display screen.

In some examples, the apparatus may be configured to enable scrolling through content in the first or second portion, which is not obscured by the detected inclination of the hand gesture, based on a particular degree of inclination of the hand gesture. It will be appreciated that since the hand gesture is performed proximal to the display screen, in certain embodiments, a part of the display screen may be obscured by the user's hand. In some examples the first portion may be selected to occupy a part of the screen that is not obscured by the user's hand. Equally, the second portion may be selected to occupy a part of the screen that is not obscured by the user's hand. FIGS. 4c and 4f illustrate an example where the first portion 404 is not obscured by the user's hand 420. FIG. 4f illustrates an example where the user makes a hand gesture in which the hand 420 is inclined relative to the display screen 400 by rotating the hand 420 by an angle 422 about an axis 430 that is approximately perpendicular to the user's fingers. Based on detecting this gesture, the apparatus is configured to scroll through the content displayed in the first portion 404. In this example the apparatus is configured to scroll down through the content. It will be appreciated that the apparatus may be configured to scroll up or down through content displayed on either of the first portion 404 or the second portion 406. Equally, the apparatus may be configured to slide the content to the left-hand-side or the right-hand-side of the first portion 404 or the second portion 406.

If the apparatus is configured to scroll or slide the content displayed, based on a detected inclination of the hand gesture, then the apparatus may be configured to scroll or slide the content to a particular point. For example, a particular degree of inclination may scroll the content comprising lines of text down by a particular number of lines of text. In some examples, the content may scroll or slide at a particular speed based on the detected degree of inclination of the hand gesture. For example, a greater degree of inclination may result in a faster rate of scrolling or sliding. Similarly, if the user reduces the degree of inclination of their hand gesture the apparatus may be configured to slow down the rate of scrolling or sliding, and for a particular degree of inclination the apparatus may be configured to stop scrolling or sliding the content.

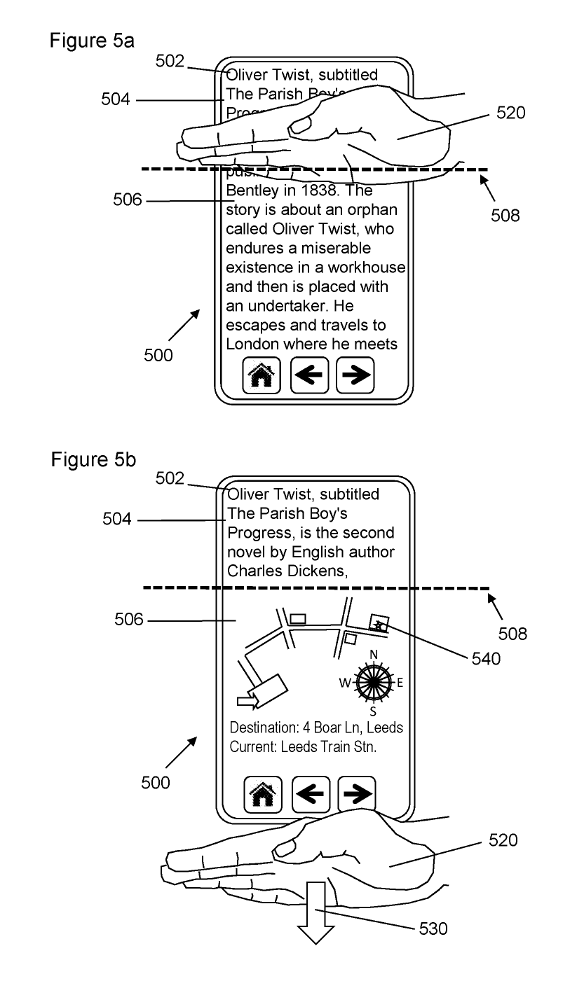

FIGS. 5a and 5b illustrate an example in which the apparatus is configured such that the delineation of the first portion 504 and the second portion 506 is based on the location of the hand gesture relative to the display screen 500. In this example, the user may desire to split the screen along a particular boundary 508. To achieve this the user makes a gesture in which they place their hand 520 along the desired boundary 508 position. The user then inclines their hand in a particular direction. In this example the user inclines their hand towards the bottom side of the screen 500 by making a gesture 530 that includes moving their hand to the bottom of the screen 500. Based on detection of this gesture 530, the apparatus is configured to split the screen 500 along the user's indicated boundary 508 and then select the top portion of the screen 500 as the first portion 504. In this example the bottom portion of the screen 500 is selected as the second portion 506. In this example the content 502 is then displayed on the first portion 504, while the second portion 506 becomes available to display different content 540.

The apparatus may display an indication of the location of the boundary to the user, which would move with lateral (e.g. up/down/left/right) movement of the hand gesture. This may be more important where the hand gesture detector is located remote from the display screen so as to provide a visual clue to the user as to where the screen is to be split.

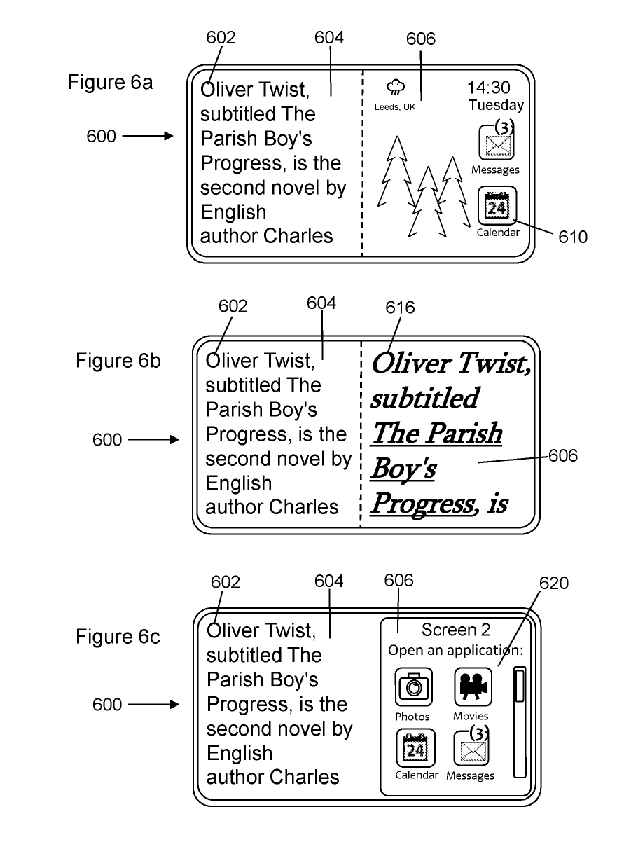

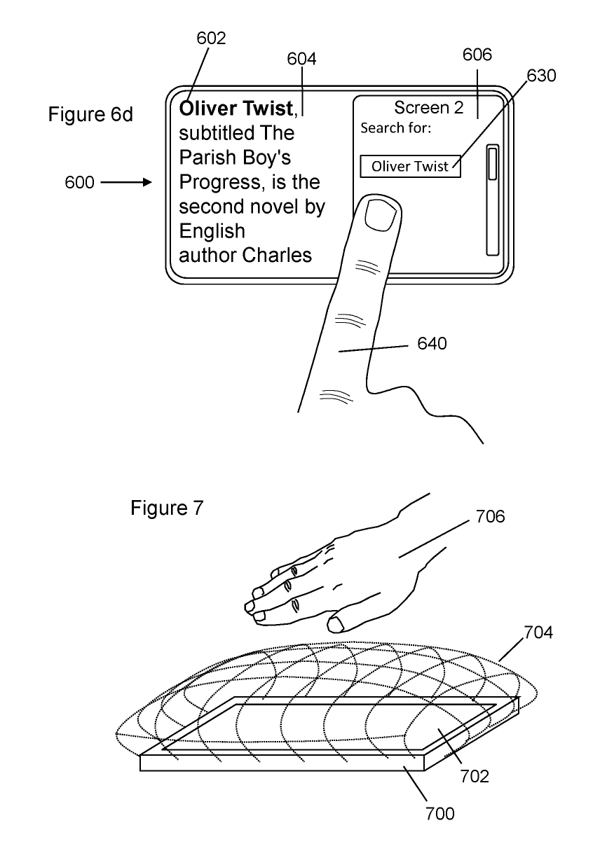

In some examples, the apparatus may be configured to size the split of the display screen into respective first portions and second portions based on a particular degree of inclination of the hand gesture. For example, the user may rotate their hand about an axis approximately parallel to the surface of the display screen, or more generally the gesture detector, and the apparatus may be configured to increase the size of the first portion, or the size of the second portion, based on the detected degree of the rotation of the user's hand. Similarly, the degree of inclination of the hand gesture may be used to control the degree of zooming of content in the first and/or second portion, for example see FIG. 6b.

FIGS. 6a to 6c illustrate examples in which the second portion 606 comprises a new viewing pane with second content 610 from a background application. FIG. 6a shows an example in which the content 602 is provided on the first portion 604 of the display screen 600 and other, second, content 610 is displayed on the second portion 606 of the display screen 600. In this example the content comprises a desktop that was previously in the background behind the content 602 when the content 602 was being displayed across the entire display screen 600. In some examples, the second portion may display second content derived from one or more other applications that were in the background, for example, obscured behind the content 602 when it was being displayed across the entire display screen 600. In other cases, this content might not have been obscured, but just not shown as it was just running in the background.

In some examples, the apparatus may be configured such that the second portion is available for displaying one of second content different to the content displayed in the first portion and new content associated with the first portion. For example, the second content may be derived from a second application that is unrelated to the application that provides the content. In some examples, the second content displayed in the second portion may be derived from the content prior to the splitting.

In some examples, the apparatus may be configured to enable display of second content in the second portion such that the second content is one of the content of the first portion displayed in a different manner to the display in the first portion, and based on different content than the content in the first portion. For example, in the former case, if the content consists of a colour picture, the second content may consist of a black and white version of the picture. Similarly, the font could be changed. In the latter case, the different content may be the provision of a web-browser or a search field which would allow browsing/searching of content different (although in some cases related) to the first portion content.

In the case of searching/browsing of related content, the browser address field or search entry field could automatically be filled in using content selected from the first portion, for example by specific user selection of the content or by automatic recognition of content from the first portion, for example auto-highlighting of text which the user can vary by changing the degree of inclination. Thus, for example, a higher inclination in one direction would move the auto-highlighting, or previous selection, to the next text in the same direction, and vice versa. This can be seen in the context of FIG. 6d where ‘Oliver Twist’ has been highlighted/selected (e.g. by specific user-selection, or auto-highlighting based on searching for one or more nouns, for example), and this is provided as a search entry in the second portion 606 (in this case, the search engine entry field) to provide for the related data. It will be appreciated that the apparatus may be configured to provide further content in the second portion, based on the selected content, automatically, or that the further content may only be provided upon a further user selection. This selection can be defined before or after the splitting.

In some examples, the apparatus is configured to enable one of display of second content in the second portion such that the second content is displayed at a different scale than the first content displayed in the first portion and display of second content in the second portion such that the second content is based on a background application. FIG. 6b illustrates an example where the second content 616 consists of text from the content 602 displayed at a larger scale. Similarly, if the content consisted of a picture, the second content may consist of a magnified region of the picture. In this case, the inclination of the user's hand gesture may be used to define both the region of the picture to be displayed and the degree of magnification preferred by the user. In another example, particular degree of inclination of the hand gesture may be varied by the user and the apparatus may be configured to display, in the second region, a magnified portion of the content in which the particular degree of magnification varies based on the particular degree of inclination of the hand gesture.

In some examples, the content of the first portion may be associated with a first application and the apparatus may be further configured to enable display of new content, associated with a second application, in the second portion. For example, the content may be text provided by a word processor application and the second portion may display a picture provided by a photo-editor application. The opening of specific applications may be based on defaults, which can be pre-set prior to the splitting or by user selection upon splitting.

In some examples, the apparatus may be configured to enable one of: presentation to a user of an option to select new content to be displayed in the second portion; presentation to a user of a plurality of icons associated with a plurality of content items, wherein selection of a particular icon enables display of the associated particular content in the second portion; and presentation to a user of a plurality of icons associated with a plurality of content items, wherein selection of a particular icon is based on a particular degree of inclination of the hand gesture and enables display of the associated particular content in the second portion.

FIG. 6c shows an example where the second portion shows a viewing pane with a menu 620 of items that the user may select from in order to display new content linked to the selected menu item. The menu 620 shown in FIG. 6c consists of a plurality of icons, however, other types of menu are possible such as an array of words or other text based descriptions of items. In one example, a particular menu item may be highlighted based on the particular degree of inclination of the hand gesture and then the highlighted item may be selected by the user by altering the hand gesture, for example by closing their hand. In another example, a particular item (for example “Photos”) on the menu 620 may be selected based on the degree of inclination where a particular degree of inclination corresponds to a particular position of the menu item. Then adjacent menu items (e.g. ‘movies’) can be selected by varying the degree of tilt, for example, towards the right in the case of ‘movie’ selection with respect to a previous highlighting of ‘Photos’. In some examples, the particular degree of inclination may correspond to a speed with which the menu items are scrolled through. For example, a high inclination angle may increase the scrolling speed with respect to a lower inclination angle. Once the desired menu item has been highlighted, the user may then select the item by inclining their hand in a new direction or by moving their hand towards or away from the screen or by moving their hand towards a particular side of the screen or by performing some other hand gesture, for example. Selection of the item may then display content associated with the item in the second portion.

In some examples, the content of the first portion may comprise one or more of an application screen, data presented within an application screen, and a desktop and second content displayed in the second portion may comprise one or more of an application screen, data presented within an application screen, and a desktop. It will be appreciated that the application, data or desktop of the second portion may or may not be associated with the content of the first portion. For example, the first portion may comprise the desktop of the apparatus while the second portion may comprise the desktop of a second apparatus that is in data communication with the apparatus. This may, for example, enable transfer of data from the apparatus, which may be a laptop computer, to the desktop of the second apparatus, which may be a smartphone linked to the laptop computer.

In some examples, the detected hand gesture may be one or more of a hover hand gesture and a touch hand gesture. A hover hand gesture may comprise a user holding their hand at a particular distance away from the display screen. A touch hand gesture may comprise the user bringing some part or parts of their hand into physical contact with the display screen. For example, a user might touch the display screen, or other gesture detector, with the edge of their hand or with the palm of their hand or the back of their hand or with one or more of their fingers.

In some examples, the detection of the inclination of the hand gesture may be based on one or more of the detection of a shadow cast by the hand gesture and a three-dimensional shape recognition of the hand gesture. In certain optional cases, the detection of the inclination may be confirmed by the hand gesture being completed by touching the user interface with the hand gesture at the end of the hand gesture.

For example, detection of a shadow cast by the hand gesture may comprise detecting a projection of the hand gesture using a camera. For example, the camera may detect a particular (or any) reduction in light and/or increase in darkness caused by the shadow. This may be detected by the apparatus, or another apparatus separate from the apparatus but which provides the appropriate detection information to the apparatus. In the case of the confirmation by completing the hand gesture by touching the user interface, the touching of the user interface at the completion of the hand gesture would confirm that the increasing darkness/reducing light was due to a hand gesture inclination detection.

Recognition of a three-dimensional shape of the hand gesture may comprise determining the particular configuration of the user's hand, both in its location relative to the display screen and in the location of different parts of the anatomy of the hand in relation to each other. Similarly, this three-dimensional shape may be detected by the apparatus, or another apparatus separate from the apparatus but which provides the appropriate detection information to the apparatus. For example, the apparatus may be configured to split the screen in a particular way, or to provide the first portion, or the second portion, at a particular location of the display screen based on recognition of a particular three-dimensional shape of hand gesture. Examples may include providing, in the second portion, a magnified image of a portion of picture content where the particular portion of the picture content is selected based on recognition of a three-dimensional pointing gesture where the user points a finger or fingers at the particular portion of the picture content. In the case of the confirmation by completing the hand gesture by touching the user interface, the touching of the user interface at the completion of the hand gesture would confirm that the hand gesture has been completed.

In some examples, the apparatus may be configured to one or more of perform the detection of the inclination of a hand gesture and receive an indication of the detected inclination of a hand gesture from another apparatus. For example, the systems required to perform the detection of the inclination of a hand gesture may be included within the apparatus. In other examples, a second apparatus may perform the detection of the inclination of the hand gesture and then provide data representative of the detected inclination of the hand gesture to the apparatus.

In the above disclosure, examples have been provided in which the apparatus may detect an inclination of a hand gesture made by only one of a user's hands. It will be appreciated that in other examples, the apparatus may detect inclinations of both a user's left hand and the user's right hand. Detection of gestures made with both of a user's hands simultaneously may provide a greater number of different gestures that may provide a greater flexibility in controlling the apparatus.

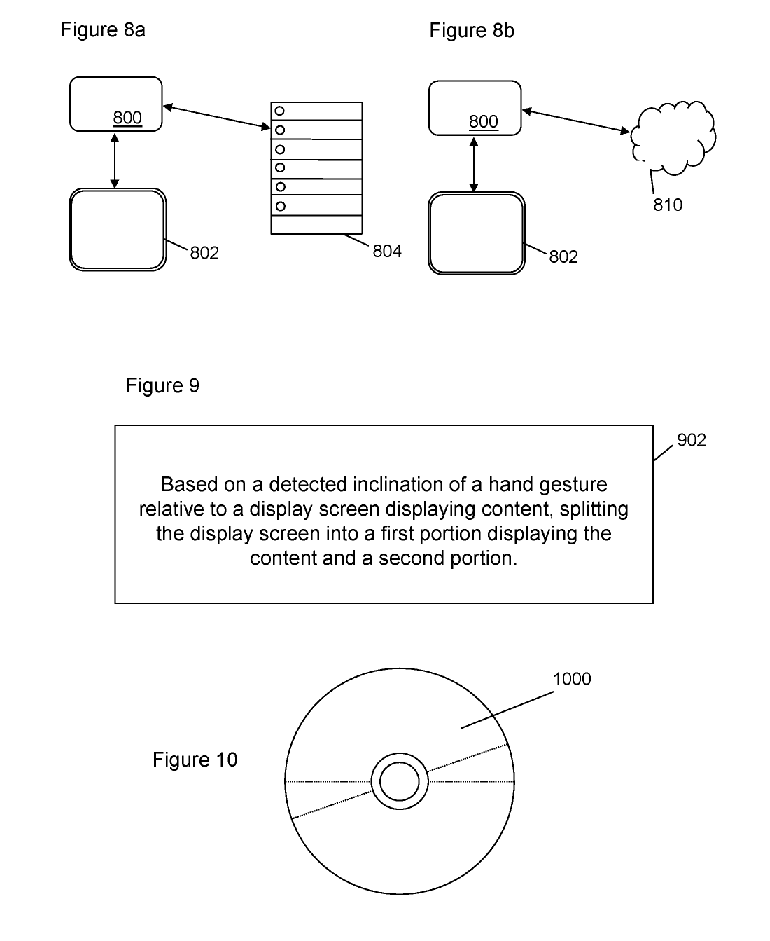

FIG. 7 illustrates detection of an inclination (including degree and direction) of a (e.g. 3-D) hand gesture user input according to examples of the present disclosure. The display screen 702 of an apparatus/device 700 may be (or be overlaid by) a 3-D hover-sensitive layer such as a capacitive sensing layer. Such a layer may be able to generate a virtual detection mesh 704 in the area surrounding the display screen 702 up to a distance from the screen 702 of, for example 3 cm, 5 cm, 7 cm, or 10 cm or more, depending on the particular layer used. The virtual mesh 704 may be generated as a capacitive field. The gesture detector need not be part of the display, and in some embodiments (e.g. FIG. 8), could be remote from it.

The 3-D hover-sensitive layer may be able to detect hovering objects 706, such as a hand, or hands, within the virtual mesh 704. In some examples the layer may also be configured to detect touch inputs (wherein the user's finger or pen, for example, make physical contact with the layer). The virtual mesh 704 may extend past the edges of the display screen 702 in the plane of the display screen 702. The virtual mesh 704 may be able to determine the shape, location, movements and speed of movement of the object 706 based on objects detected within the virtual mesh 704. Thus, for example, the virtual mesh 704 may be able to discriminate between different inclinations of a hand gesture user input as described herein, and may be able to determine the position and location of the user's hand(s) relative to the display screen 702.

In other examples, an inclination of a hand gesture may be detected and/or confirmed by one or more of: a camera, an infra-red camera, a heat sensor and a light sensor.

FIG. 8a shows an example of an apparatus 800 in communication with a remote server. FIG. 8b shows an example of an apparatus 800 in communication with a “cloud” for cloud computing. In FIGS. 8a and 8b, apparatus 800 (which may be apparatus 100, 200 or 300) is also in communication with a further apparatus 802. The further apparatus 802 may be for example a detecting device configured to detect a user's hand presence, position or inclination. In other examples, the apparatus 800 and further apparatus 802 may both be comprised within a device such as a portable communications device or PDA. Communication may be via a communications unit, for example.

FIG. 8a shows the remote computing element to be a remote server 804, with which the apparatus 800 may be in wired or wireless communication (e.g. via the internet, Bluetooth, NFC, a USB connection, or any other suitable connection as known to one skilled in the art). In FIG. 8b, the apparatus 800 is in communication with a remote cloud 810 (which may, for example, be the Internet, or a system of remote computers configured for cloud computing). For example, the apparatus at which the displayed content is stored may be located at a remote server 804 or cloud 810 and accessible by the first apparatus 800. In other examples the second apparatus may also be in direct communication with the remote server 804 or cloud 810.

FIG. 9 shows a flow diagram illustrating the method 902 comprising, based on a detected inclination of a hand gesture relative to a display screen displaying content, splitting the display screen into a first portion displaying the content and a second portion.

FIG. 10 illustrates schematically a computer/processor readable medium 1000 providing a program according to an example. In this example, the computer/processor readable medium is a disc such as a digital versatile disc (DVD) or a compact disc (CD). In other examples, the computer readable medium may be any medium that has been programmed in such a way as to carry out an inventive function. The computer program code may be distributed between the multiple memories of the same type, or multiple memories of a different type, such as ROM, RAM, flash, hard disk, solid state, etc.

The apparatus shown in the above examples may be a portable electronic device, a laptop computer, a mobile phone, a smartphone, a tablet computer, a smart television, a personal digital assistant, a navigation device, a watch, a digital camera, a non-portable electronic device, a server, a desktop computer, a monitor/display, or a module/circuitry for one or more of the same.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some examples, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such examples can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc.), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/examples may consist of any such individual feature or combination of features. In view of the foregoing description it will be evident to a person skilled in the art that various modifications may be made within the scope of the disclosure.

While there have been shown and described and pointed out fundamental novel features as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or examples may be incorporated in any other disclosed or described or suggested form or example as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-29. (canceled)

30. An apparatus comprising:
at least one processor; and
at least one memory including computer program code,
the at least one memory and the computer program code configured to, with the at least one processor, cause the apparatus to perform at least the following:
based on a detected inclination of a hand gesture relative to a display screen displaying content, split the display screen into a first portion displaying the content and a second portion.

31. The apparatus of claim 30, wherein the inclination is with respect to a particular side of the display screen and wherein the particular side is one of a left-hand side, right-hand side, top side, bottom side, top-left-hand corner, top-right-hand corner, bottom-left-hand-corner, and bottom-right-hand corner.

32. The apparatus of claim 30, wherein the apparatus is configured such that an inclination towards a particular side of the display screen splits the display screen with the first portion being displayed on that particular side of the display screen.

33. The apparatus of claim 30, wherein the apparatus is configured such that an inclination towards a particular side of the display screen splits the display screen with the first portion being displayed on an opposing side to that particular side of the display screen.

34. The apparatus of claim 30, wherein the apparatus is configured such that the second portion is displayed on an opposing side of the display to the first portion.

35. The apparatus of claim 30, wherein the apparatus is configured to enable scrolling through content in the first or second portion, which is not obscured by the detected inclination of the hand gesture, based on a particular degree of inclination of the hand gesture.

36. The apparatus of claim 30, wherein the apparatus is configured to size the split of the display screen into respective first portions and second portions based on a particular degree of inclination of the hand gesture.

37. The apparatus of claim 30, wherein, based on a selected at least part of the content, provide for further content in respect of the selected part in the second portion.

38. The apparatus of claim 37, wherein the selected at least part of the content is used as a search entry for searching for further data to be provided in the second portion.

39. The apparatus of claim 38, wherein the search entry is automatically filled based on user selection of content from the first portion or by automatic recognition of content from the first portion.

40. The apparatus of claim 39, wherein the automatic recognition includes auto-highlighting of text which the user can vary by changing the degree of inclination or auto-highlighting one or more nouns from the first portion content.

41. The apparatus of claim 30, wherein the second portion comprises a new viewing pane with second content from a background application.

42. The apparatus of claim 30, wherein the apparatus is configured to enable display of second content in the second portion such that the second content is one of the content of the first portion displayed in a different manner to the display in the first portion and based on different content than the content in the first portion.

43. The apparatus of claim 30, wherein the apparatus is configured to enable display of second content in the second portion such that the second content is displayed at a different scale than the first content displayed in the first portion.

44. The apparatus of claim 30, wherein the second portion provides a web-browser or search field which allows for browsing/searching of content different to the first portion content.

45. The apparatus of claim 30, wherein the detection of the inclination of the hand gesture is based on one or more of the detection of a shadow cast by the hand gesture and a three-dimensional shape recognition of the hand gesture.

46. A method comprising, based on a detected inclination of a hand gesture relative to a display screen displaying content, splitting the display screen into a first portion displaying the content and a second portion.

47. A computer readable medium comprising computer program code stored thereon, the computer readable medium and computer program code being configured to, when run on at least one processor, perform at least the following:
based on a detected inclination of a hand gesture relative to a display screen displaying content, split the display screen into a first portion displaying the content and a second portion.
